(19) United States
(12) Patent Application Publication
(10) Pub. No.: US 2025/0338313 A1
(43) Pub. Date: Oct. 30, 2025

(54) Methods and Apparatus for Channel Occupancy Time (COT) Sharing in New Radio (NR) and/or Sidelink-Unlicensed (SL-U)

(71) Applicant: Charter Communications Operating, LLC, St. Louis, MO (US)

(72) Inventors: Mehdi Ganji, Santa Rosa, CA (US); Dumitru M. Ionescu, Poway, CA (US)

(21) Appl. No.: 18/645,302

(22) Filed: Apr. 24, 2024

(51) Int. Cl. H04W 74/0816; H04W 72/25; H04W 74/00

(52) U.S. Cl. CPC H04W 74/0816; H04W 72/25; H04W 74/002

(57) ABSTRACT

Methods and apparatus for fair COT sharing in NR-U and/or SL-U are described. Type 2C channel access (without sensing) with regard to COT sharing for NR-U and/or SL-U is restricted based on the distance between an initiator device and a responding device. An initiator device determines a maximum distance threshold value, e.g., a COT-SharingRange2C value, and communicates the value to the responding UE as part of COT sharing information. The responding UE uses the communicated maximum distance threshold value along with a determined distance (D) between the initiator device and the responding UE to determine whether or not the responding UE is allowed to use the type 2C channel access procedure or is to use a channel access procedure requiring sensing. By restricting the type 2C CA for responding UEs located near coverage boundaries, collisions between responding UEs and out-of-sight UEs are reduced.

### FIELD

The present application relates to wireless communications systems and more particularly to methods and apparatus for supporting fair COT sharing, e.g., in NR-U and/or SL-U.

### BACKGROUND

Some background will regard to New Radio-Unlicensed (NR-U) will now be described. A Channel Occupancy Time (COT) refers to the total time for which any gNB/UE(s) sharing the channel occupancy perform transmission(s) on a channel after it performs the corresponding channel access procedure described in 3rd Generation Partnership Project, Technical Specification Group Radio Access Network, specification titled Physical layer procedures for shared spectrum channel access which published as 3GPP TS 37.213 V18.1.0 (2023-12). This specification is hereby incorporated by reference in its entirety and will be hereinafter referred to as TS 37.213. A channel access procedure is a procedure based on sensing that evaluates the availability of a channel for performing transmissions. A gNB/UE may transmit a transmission using Type 1 channel access after first sensing the channel to be idle during the sensing durations of a defer duration and after a random back-off duration specified by channel access priority class (CAPC) in Table 4.1.1-1 of TS 37.213. Based on 3GPP NR-U specifications, a COT can be shared for transmission between a gNB and the corresponding UE(s). If a UE shares a channel occupancy initiated by a gNB, the UE may transmit a transmission that follows a DL transmission on scheduled resources after a gap as follows: i) if the gap is up to 16 μs, the UE can transmit the transmission on the channel after performing Type 2C channel access; ii) if the gap is 25 μs or 16 μs, the UE can transmit the transmission on the channel after performing Type 2A or Type 2B channel access procedures, respectively. COT Sharing information in NR-U will now be described.

COT sharing information can be configured by RRC (radio resource control) message and be exchanged between user equipment (UE) and gNB.

| CG-COT-Sharing-r16 ::= CHOICE { | |
|---|---|
| noCOT-Sharing-r16 | NULL, |
| cot-Sharing-r16 | SEQUENCE { |
| duration-r16 | INTEGER (1..39), |
| offset-r16 | INTEGER (1..39), |
| channelAccessPriority-r16 | INTEGER (1..4) |
| } | |
| } | |
| CG-COT-Sharing-r17 ::= CHOICE { | |
| noCOT-Sharing-r17 | NULL, |
| cot-Sharing-r17 | SEQUENCE { |
| duration-r17 | INTEGER (1..319), |
| offset-r17 | INTEGER (1..319) |

```
    }
  }
```

ChannelAccessPriority-r16 indicates the Channel Access Priority Class that the UE can assume when sharing the gNB initiated COT. Duration-r16/duration-r17 indicates the number of transmission slots within shared COT. Offset-r16/offset-r17 indicates the number of transmission slots from the end of the slot where the grant is detected after which COT sharing can be used.

Some background with regard to Sidelink-Unlicensed (SL-U) will now be described. Sidelink is a 3GPP access technology intended to provide direct connectivity between devices positioned inside or outside of a cell coverage area. SideLink has been gradually developed by 3GPP starting with Release 12 and continuing during the current Release 18. Sidelink unlicensed (SL-U) is operating in unlicensed/shared spectra in bands n46 and n96 (5 GHz and 6 GHz bands).

If a responding UE shares a channel occupancy initiated by a COT initiating UE using the channel access Type 1, the responding UE may transmit a SL transmission that follows a SL transmission by the COT initiating UE after a gap as follows.
If the gap is 25 μs, the responding UE can transmit the SL transmission on the shared channel after performing Type 2A SL channel access procedures.
If the gap is equal to 16 μs, the responding UE can transmit the SL transmission on the shared channel after performing Type 2B SL channel access procedures.

If the gap is up to 16 μs and the transmission is limited to 584 μs, the responding UE can transmit the SL transmission on the channel after performing Type 2C SL channel access.

COT sharing information in Sidelink will now be described. It is also agreed in ongoing 3GPP Release 18 meetings to include the following information as part of COT sharing information.
At least the following information should be used as part of COT sharing information from the COT initiator UE.
CAPC (Channel Access Priority Class) used for initiating the COT
Existing/legacy R16/17 L1 source and destination IDs
FFS (For Further StudY) additional ID(s).
Time domain information of the shared COT
FFS: starting offset, number of slots, [remaining or total] COT duration, or a combination of them.
Frequency domain information of the shared COT
FFS applicable RB (Resource Block) set(s), FRIV, and any other(s)

A problem with regard to COT sharing in NR-U and SL-U, will now be described. In both NR-U and SL-U, the gNB or the initiator UE can share their obtained COT to another UE. The responding UE applies channel access type 2 (A/B/C) based on the gap between its transmission and the initiator's transmission to use the shared COT. In channel access type 2 (A/B), the responding UE is responsible to sense the channel for at least two or one sensing slot, respectively. However, with the channel access type 2 C, the responding U can start its transmission within a gap of 16 μs from the initiator's transmission without sensing the channel. Since the responding UE does not sense the channel in the channel access type 2 C, its transmission can interfere with transmission of other devices which are out the initiator's coverage (hidden to initiator) and operate on the same unlicensed bands. As a result, using a shared COT with channel access type 2 C can be unfair and problematic to other technologies operating on unlicensed bands such as IEEE 802.11 devices.

There is an out-of-sight node problem with regard to COT sharing in NR-U and SL-U. Here, we use the term, out-of-sight node to refer to the nodes that are out of the gNB/UE coverage and cannot sense that the channel is busy. The responding UEs who share the COT and perform Type C channel access might interrupt the transmission of out-of-sight nodes who did not sense the channel being busy.

FIG. 1 illustrates an exemplary communications system 100 including a gNB 102 with a coverage area 103 and a plurality of UEs (UE 1 104, UE 2 106, UE 3 108, UE 4 110). UE 1 104 and UE 3 108 are currently located within coverage area 103, while UE 2 106 and UE 4 110 are currently located outside of coverage area 103.

In the FIG. 1 example, UE2 106 and UE4 110 are out-of-sight nodes with respect to gNB 102 and cannot sense the channel being occupied by gNB 102. Consider that gNB 102 decides to share its COT with UE 1 104, as indicated by COT sharing information 116 being communicated from gNB 102 to UE 104. Bi-directional arrow 112 indicates communications between gNB 102 and UE 1 104, which includes a downlink transmission from gNB1 102 using a first portion of a shared COT, and an uplink transmission from UE 1 104 to gNB 102 using a second portion of the shared COT. The uplink transmission from UE 1 104 can potentially cause interference to other UEs within the area 105.

If UE1 104 performs channel access 2C (with no sensing) to access the shared COT, initiated by gNB 104, it will interfere with transmission 114 of out-of-sight nodes, i.e., UE2 106 and UE4 110.

FIG. 2 includes a signaling diagram 200 and corresponding legend 201 used to illustrate the out-of sight node problem of FIG. 1 in more detail. Legend 201 indicates that: widely spaced diagonal line shading is used to indicate type 1 CA and closely spaced diagonal line shading is used to indicate type 2-C CA with no sensing.

In this example gNB 102 shares its COT 202 with UE 1 104. The gNB 102 performs type 1 CA, as indicated by block 204, followed by transmission 206 from gNB during the time interval T_0 to T_2 (203 to 207) of COT 202. During the time interval T_0 to T_2 (203 to 207) UE 1 104 senses that the channel is busy, as indicated by dashed line block 208. Then, UE 1 104 performs, e.g. based on a gap determination of less than 16 micro-sec, a Type 2-C channel access (CA) with no sensing, as indicated by block 210, and UE 1 104 performs a transmission 212, using the remainder of the COT 202. UE 2 106, which is an out-of-side node, does not sense the transmission 206 by gNB 102 on the channel. UE 2 106 performs a type 1 channel access 214, which ends with a channel clear determination at time T_1 205. Then UE 2 106 starts transmission 216 from UE 2 106 directed to UE 4 110. As a result of the time overlap between transmission 212 and transmission 216, there is a collision at UE 4 218, as indicated by the encircled X 214. During the time interval T_0 to T_2 (203 to 207) UE 3 108 senses that the channel is busy, as indicated by dashed line block 220. Then, UE 3 108 performs a type 1 channel access 224 starting at time T_2 224, which senses the channel to be busy and thus there is no transmission from UE 3 108, as indicated in information block 226.

To summarize, in the example, described with respect to FIG. 1 and FIG. 2, assume gNB 102 performs Type 1 channel access 204 and occupies the channel at time T_0 203. The gNB 102 uses a portion of its COT 202 to transmit its own transmission 206 from T_0 203 to T_2 207. During gNB transmission 206, UE 1 104 and UE 3 108, which are within gNB's coverage 103, sense the channel to be busy (208, 220) and refrain from transmission. However, UE 2 106, which is an out-of-sight node with respect to gNB 102, could perform Type 1 channel access 214 and start transmission 216 at T_1 205. Now, if UE 1 104 performs Type 2C CA (with no sensing) 210 at T_2 207 and then uses the shared COT 202, its transmission 212 will cause interference at UE 4 110, which is the destination of UE 2's transmission 216. Note that UE 3 108 will refrain from transmission, when it performs CA type 1 224. The issue is not sensing the channel in CA 2C, performed by UE1 104.

Based on the above discussions, there is a need for new method and apparatus to reduce, eliminate, and/or mitigate interference to UEs, e.g., out-of-sight UEs, when COT is being shared in NR-U and/or SL-U.

### SUMMARY

Methods and apparatus for supporting fair COT sharing in NR-U and/or SL-U are described. Type 2C channel access (channel access without sensing) with regard to COT sharing for NR-U and/or SL-U is restricted based on the distance between an initiator device and a responding device. An initiator device determines a maximum distance threshold value, e.g., a COT-SharingRange2C value, and communicates the value to the responding UE as part of a generated set of COT sharing information. The responding UE receives the COT sharing information and recovers the maximum distance threshold value. The responding UE determines the distance (D) between the location of the initiating device and location of the responding UE. The responding UE compares the determined distance (D) to the maximum distance threshold value. If the comparison indicates that the determined distance D is less than the maximum distance threshold value, then the responding UE is allowed to perform a type 2C CA (without sensing) (e.g., for case where gap is less than 16 micro-seconds); otherwise, the responding UE performs a CA procedure which includes sensing, e.g. a type 2B CA procedure. If the responding UE is not able to determine its current location, e.g., to within a predetermined accuracy, the responding UE is not allowed to perform type 2C CA (without sensing) and uses a CA procedure which includes sensing. By restricting the type 2C CA for responding UEs with regard to COT sharing for NR-U and SL-U, in accordance with features of the present invention, the interference produced by responding UEs to out-of-sight UEs is reduced, mitigated, or eliminated, thus reducing collisions between responding UEs and out-of-sight UEs, and thus providing a fairer operational environment.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary prior art communications system supporting NR-U in which COT sharing may occur resulting in unacceptable interference to out-of-sight UEs.

FIG. 2 is a drawing illustrating exemplary signaling in a prior art communications system in which interference is experienced by an out-of-sight UE due to a transmission collision involving COT sharing.

FIG. 3 is a drawing of an exemplary communications system, in accordance with an exemplary embodiment, in which interference from COT sharing to out-of-sight UEs is eliminated, mitigated, or reduced, e.g., by methods and apparatus which limit type 2-C channel access (CA), with regard to COT sharing for NR-U and/or SL-U, to responding UEs within a specified distance of the initiator device.

FIG. 4 is a drawing of an exemplary communications system, in accordance with an exemplary embodiment.

FIG. 5A is a first part of a flowchart of an exemplary method of operating a communications system in accordance with an exemplary embodiment.

FIG. 5B is a second part of a flowchart of an exemplary method of operating a communications system in accordance with an exemplary embodiment.

FIG. 5 comprises the combination of FIG. 5A and FIG. 5B.

FIG. 6 is a drawing of an exemplary base station, e.g., a gNB, supporting NR-U and SL-U, in accordance with an exemplary embodiment.

FIG. 7 is a drawing of an exemplary user equipment (UE) supporting NR-U and SL-U, in accordance with an exemplary embodiment.

FIG. 8 is a drawing illustrating a more detailed representation of a set of information included in the UE of FIG. 7, with the UE acting as a responding device for COT sharing for NR-U.

FIG. 9 is a drawing illustrating a more detailed representation of a set of information included in the UE of FIG. 7, with the UE acting as an initiator device for COT sharing for SL-U.

FIG. 10 is a drawing illustrating a more detailed representation of a set of information included in the UE of FIG. 7, with the UE acting as a responding device for COT sharing for SL-U.

FIG. 11 is a drawing illustrating an example in which an exemplary UE decides, in accordance with the method of the present invention, to perform type 2C channel access with regard to shared COT resources in NR-U.

FIG. 12 is a drawing illustrating an example in which an exemplary UE decides, in accordance with the method of the present invention, to perform type 2B channel access with regard to shared COT resources in NR-U.

FIG. 13 is a drawing illustrating another example in which an exemplary UE decides, in accordance with the method of the present invention, to perform type 2B channel access with regard to shared COT resources in NR-U.

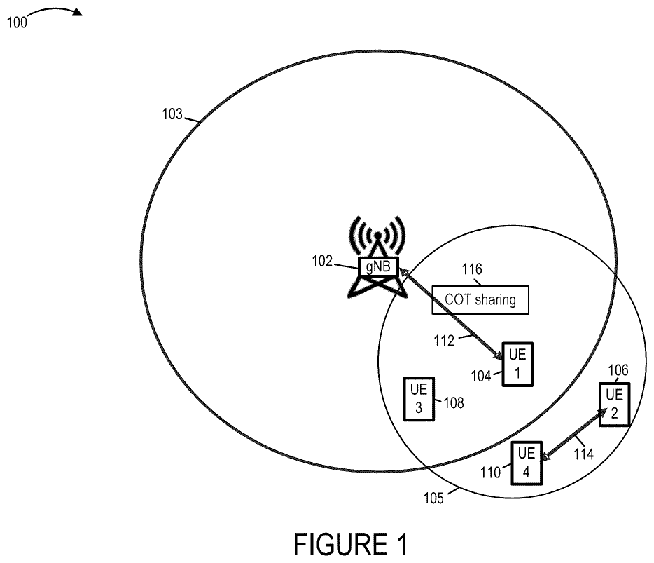

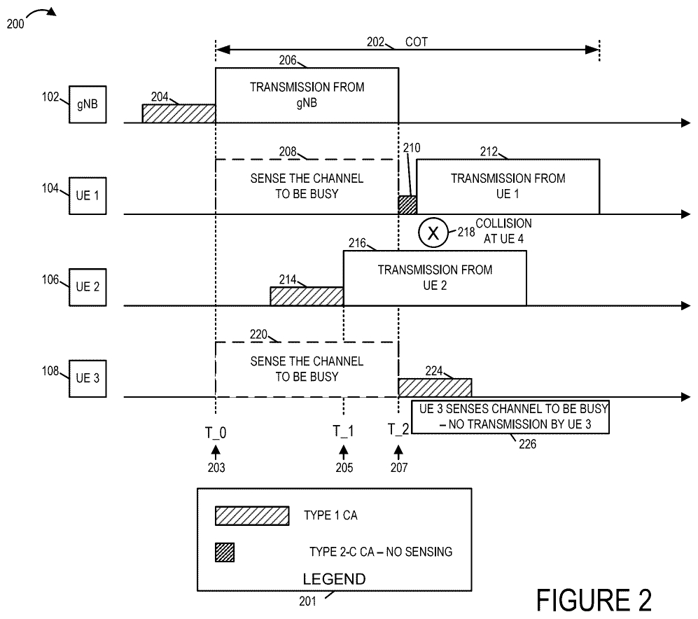

### DETAILED DESCRIPTION

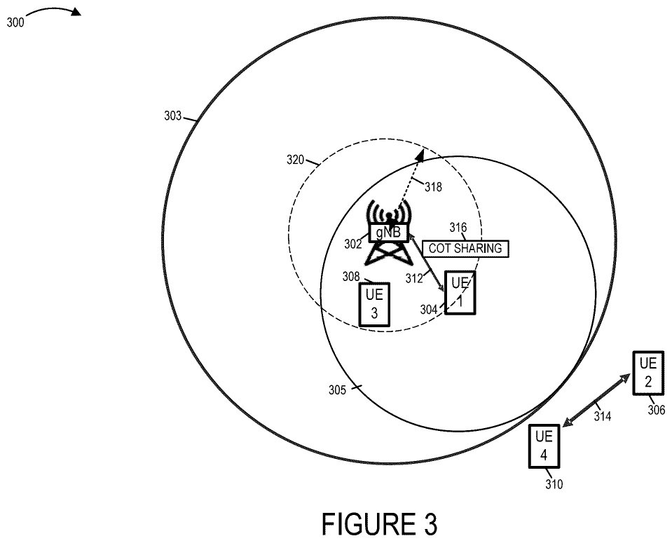

FIG. 3 illustrates an exemplary communications system 300 including a base station 302, which is a gNB, with a coverage area 303 and a plurality of UEs (UE 1 304, UE 2 306, UE 3 308, UE 4 310). UE 1 304 and UE 3 308 are currently located within coverage area 303, while UE 2 306 and UE 4 310 are currently located outside of coverage area 303. In accordance with a feature of some embodiments of the present invention, distance-based COT sharing is used to minimize the effect of the out-of-sight node problem. Channel Access (CA) type 2C is only permitted to the UEs that are within a pre-specified distance 318 from the gNB 302, e.g., located withing dashed line circle 320. In this way, the UEs that use the shared COT with CA 2C (with no sensing), will have minimized interference at out-of-sight nodes, i.e., UE4 310 and UE2 306.

The interference to out-of-sight UEs, will approach to zero if the circle 305 (representing coverage of the responding UE 1 304) is confined withing the larger circle 304 (representing the coverage of the initiator gNB 302).

To limit the out-of-sight node problem, in accordance with a feature of an exemplary embodiment, the permitted distance 318 (a maximum range) for performing Type 2C CA (for cases in which gap is less than 16 micro-seconds), is included in the COT sharing information 316 and is communicated from the initiator gNB 302 to the responding UE, UE 1 302, with which the COT is being shared.

In some embodiments, a COT-SharingRange2C value is included in the COT sharing information, wherein said COT-SharingRange2C is referred to as the distance from the COT initiator in which accessing the shared COT with Type 2C CA is permitted by a responding UE.

For the responding UE, e.g. UE 1 304, to be able to calculate the distance from the initiator, in some embodiments, the location of the initiator, e.g., the location of gNB 302, is included in the COT sharing information, if not already included as Zone_id.

Using the information about its location and the location of initiator, included in the COT sharing information, the responding UE, e.g., UE 1 304, can calculate its distance to the initiator, e.g., gNB 302.

If the calculated distance is less than COT-SharingRange2C, the responding UE, e.g. UE 1 304, is permitted to use Type 2C CA (when gap is less than 16 micro-seconds), otherwise, it should use either Type 2A or 2B CA to access the shared COT.

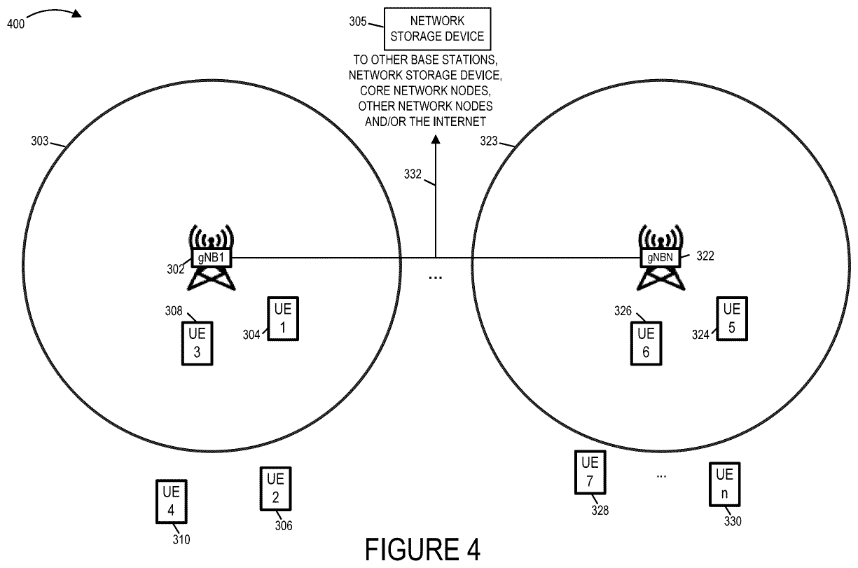

FIG. 4 is a drawing of an exemplary communications system 400, in accordance with an exemplary embodiment. Exemplary communications system 400 supports NR-U and SL-U communications and supports exemplary methods for implementing fair COT sharing. Exemplary communications system 400 includes a plurality of base station, e.g., gNBs, (base station 1 302, e.g., gNB 1, . . . , base station N 322, e.g. gNB N) and a plurality of UEs (UE 1 304, UE 2 306, UE 3 308, UE 4 310, UE 5 324, UE 6 326, UE 7 338, . . . , UE N 330). At least some of the UEs are mobile communications devices, which may move throughout the system 400. UE 1 304 and UE 3 308 are shown as being currently located within the wireless coverage area 303 of base station 1 302. UE 5 324 and UE 6 326 are shown as being currently located within the wireless coverage area 323 of base station N 322. UE 2 306, UE 4 310, UE 7 328 and UE n 330 are shown as being currently located outside of the cellular coverage areas 303, 223.

A base station, e.g., gNB 1 302, may, and sometimes does, share NR-U COT resources with a UE, e.g., UE 1 302, within its coverage area. In order to reduce or eliminate potential interference, e.g., collisions, with regard to UEs operating outside the cellular coverage area, methods and apparatus are implemented to limit the use of the type 2C channel access procedure with regard to responding UEs which are sharing COT resources granted by an initiating base station. In some embodiments, the determination as to whether a responding UE is allowed to perform type 2C channel access with regard to the COT sharing is based on whether or not the responding UE knows its location, e.g., to within an acceptable accuracy level, and the location of the responding UE with respect to a maximum distance threshold value from the base station which is initiating the COT sharing. For responding UEs located close to the initiating base station, type 2C channel access is permitted, while for responding UEs located far away from the initiating base station, e.g., near the outer boundaries of the cellular coverage area, type 2C channel access is not permitted with regard to the COT sharing. This conditional restriction of type 2C channel access, reduces, mitigates, or eliminates interference with respect to out-of-sight UEs, which are located outside the cellular coverage area.

Similarly, a UE, e.g., UE 2 306, may, and sometimes does, share SL-U COT resources with a UE, e.g., UE 4 310, within its coverage area. In order to reduce or eliminate potential interference, e.g., collisions, with regard to UEs operating outside the coverage area of UE 2 306, methods and apparatus are implemented to limit the use of the type 2C channel access procedure with regard to responding UEs which are sharing COT resources granted by an initiating UE. In some embodiments, the determination as to whether a responding UE is allowed to perform type 2C channel access with regard to the COT sharing is based on whether or not the responding UE knows its location, e.g., to within an acceptable accuracy level, and the location of the responding UE with respect to a maximum distance threshold value from the UE which is initiating the COT sharing. For responding UEs located close to the initiating UE, type 2C channel access is permitted, while for responding UEs located far away from the initiating UE, e.g., near the outer boundaries of the initiating UEs coverage area, type 2C channel access is not permitted with regard to the COT sharing. This conditional restriction of type 2C channel access, reduces, mitigates or eliminates interference with respect to out-of-sight UEs, which are located outside the coverage area of the initiating UE.

In some embodiments, the initiator device, e.g., initiator base station or initiator UE, with regard to the COT sharing determines and sends a maximum distance threshold value, e.g., a COT-SharingRange2C value, as part of the COT sharing information. In some such embodiments, the initiator device further includes information indicating the location of the initiator device or information, e.g., a device ID, which can be used by the responding UE to determine the location of the initiator device. The responding UE determines the distance between the initiator device and responding UE and uses the received maximum distance threshold value in making a decision as to whether or not the responding UE is permitted to use type 2C channel access procedure (with no sensing) with regard to its transmission using the granted shared COT resources.

The exemplary communications system 400 further includes network storage device 305, e.g., a server, which includes stored information, e.g., a table, mapping identifiers (e.g., BS IDs) of fixed location devices (e.g., fixed location base stations) to locations. The location mapping information in network storage device 305 may be updated when a new base station is added to the system or activated. In addition, the location mapping information included in network storage device 305 may be, and sometimes is, downloaded by UE devices to be available to determine a fixed location initiator device location for COT sharing, e.g. with regard to NR-U. The base stations (BS 1 302, . . . , BS N 322) are coupled together, to network storage device 305, to other network nodes including core network nodes, and/or to the Internet, via backhaul network 322, e.g., a network including wireline and/or fiber optic communications links. The UEs may be coupled to a base station via wireless communications links, e.g., using NR-U spectrum. The UEs may also be coupled to one another via wireless communications links, e.g., using SL-U spectrum.

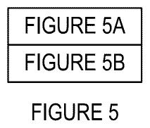

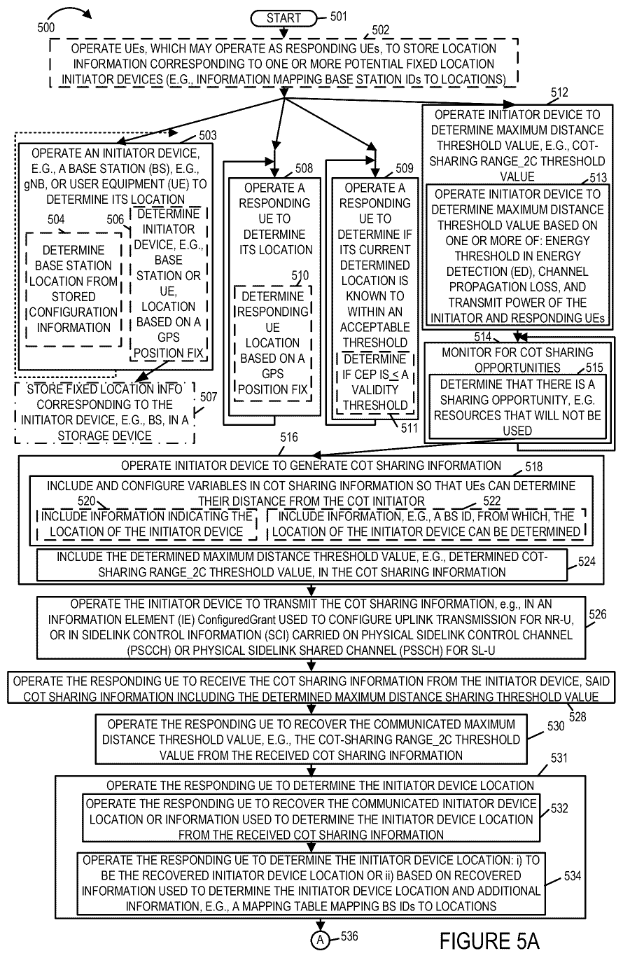

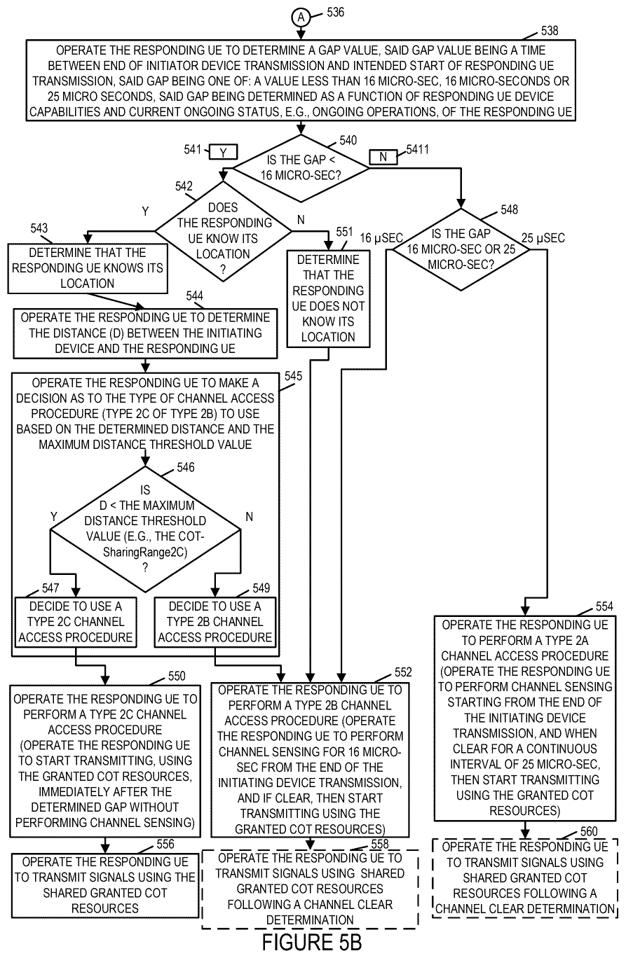

FIG. 5, comprising the combination of FIG. 5A and FIG. 5B, is a flowchart 500 of an exemplary communications method in accordance with an exemplary embodiment. Operation starts in step 501 in which the communications system, e.g., communications system 400 of FIG. 4, is powered on and initialized. In some embodiments, operation proceeds from start step 501 to optional step 502. In other embodiments, operation proceeds from start step 501 to steps 503, 508, 509 and 512, which may be performed in parallel.

Returning to step 502, in step 502 UEs, which may operate as responding UEs, with regard to COT sharing, are operated to store location information corresponding to one or more potential fixed location initiator devices, e.g., store a set of information mapping base station IDs to corresponding locations. Operation proceeds from step 502 to steps 503, 508, 509 and 512, which may be performed in parallel.

In step 503 an initiator device (with regard to COT sharing), e.g. a base station (BS) such as a gNB, or a user equipment (UE), is operated to determine its location. Step 503 includes step 504 or step 506. In step 504 the initiator device, which is a base station, determines its location from stored configuration information. In step 506 the initiator device, e.g., a base station or a UE, determines its location based on a GPS position fix. In some embodiments, the initiator device is a fixed location base station, and operation proceeds from step 506 to step 507, in which the fixed location base station stores its determined location and its BS ID, in a storage device, e.g., network storage device 305. In some embodiments, in the initiator device may change its location, and step 503 including step 506 is performed multiple times, e.g., with the current location of the initiator device being updated and stored in the initiator device.

In step 506 a responding UE is operated to determine its location. Step 508 includes step 510, in which the responding UE determines its location based on a GPS position fix. In some embodiments, the responding device may, and sometimes does, utilize additional information, e.g., gyroscope and/or accelerometer measurements from an IMU included in the responding UE, to determine its location. The additional information is useful in determining a location when GPS signals are unavailable or degraded. Step 508 is performed repetitively, on an ongoing basis, and the determined current location is stored and/or updated within the responding UE.

In step 509 the responding UE is operated to determine if the current determined location of the responding UE is known to within an acceptable threshold. In some embodiments, step 509 includes step 511, in which the responding UE determines if the circular error probable (CEP), corresponding to determined location of step 508, is less than or equal to a predetermined validity threshold. In some embodiments, when the CEP is determined to be less than or equal to the validity threshold, the responding UE is considered to have obtained a valid position fix and is considered to know its location; otherwise, the position fix is considered to be a low accuracy position fix, and the responding UE is considered to not know its location. Although described in terms of CEP, other measures of accuracy e.g., R95 or 2 drms, may be, and sometimes are, used in determining whether or not the responding UE's location is known to within an acceptable validity threshold.

In step 512 an initiator device is operated to determine a maximum distance threshold value, e.g., a COT-sharing range_2C threshold value. Step 512 includes step 513, in which the initiator device determines a maximum distance threshold value based on one or more or all of: energy threshold in energy detection (ED), channel propagation loss, and transmit power or the initiator device and responding UEs. Operation proceeds from step 512 to step 514.

In step 514 the initiator device monitors for COT sharing opportunities. Step 514 is performed repetitively, on an ongoing basis. Step 514 may, and sometime does, include step 515, in which the initiator device determines that there is a sharing opportunity, e.g., there are resources in a COT that will not be used by the initiator device. Operation proceeds from step 515 to step 516.

In step 516 the initiator device generates COT sharing information. Step 516 includes step 518 and step 524. In step 518 the initiator device includes and configures variables in COT sharing information so the UEs (responding UEs) can determine their distance from the COT initiator. In some embodiments step 518 includes step 520 or step 522. In step 520 the initiator device includes information indicating the location of the initiator device in the COT sharing information. In some embodiments, the information indicating the location of the initiator device is included as a zone ID value. In step 522, the initiator device includes information, e.g., a base station (BS) identifier (ID) of the base station, which is the initiator device, from which the location of the initiator device can be determined, e.g., via using a BS ID to location mapping table, stored in the responding UE. In step 524, the initiator device includes the determined maximum distance threshold value, e.g., the determined COT-sharing range_2C threshold value, in the COT sharing information. Operation proceeds from step 516 to step 526.

In step 526 the initiator device transmits the COT sharing information, e.g., in an information element (IE) ConfiguredGrant used to configure uplink transmission for NR-U or in Sidelink Control Information (SCI) carried on Physical Sidelink Control Channel (PSCCH) or Physical Sidelink Shared Channel (PSSCH) for SL-U. Operation proceeds from step 526 to step 528. SCI is normally carried in two phases, with the first phase communicating SCI in the PSCCH and the second phase communicating SCI in the PSSCH. Thus SCI can be communicated using either the PSCCH and/or the PSSCH. COT sharing information is mostly transported in 2nd phase of SCI using the PSSCH). Thus it should be appreciated that the COT sharing information can be, in accordance with the invention, communicated to a UE from an initiator device using either the PSCCH and/or the PSSCH. Which of the two channels or whether both channels are used depends on the particular embodiment but both channels are contemplated and one channel or both channels are used for communicating the COT sharing information generated in accordance with the invention with the particular channel used depending on the embodiment being implemented.

In step 528 the responding UE receives the COT sharing information from the initiator device, said COT sharing information including the determined maximum distance sharing threshold and initiator device location information or information that can be used to derive the initiator device's location. Operation proceeds from step 528 to step 530.

In step 530 the responding UE recovers the communicated maximum distance threshold value, e.g., the COT-sharing range_2C threshold value from the received COT sharing information. Operation proceeds from step 530 to step 531. In step 531 the responding UE determines the initiator device location. Step 531 includes steps 532 and 534. In step 532 the responding UE recovers the communicated initiator device location or information, e.g., a BS ID, used to determine the initiator device location from the received COT sharing information. Operation proceeds from step 532 to step 534. In step 534 the responding UE determines the initiator device location: i) to be the recovered initiator device location or ii) based on the recovered information used to determine the initiator device location and additional information, e.g., a stored mapping table mapping BS IDs to locations. Thus, in some embodiments, the responding UE determines the initiator device location directly from initiator device location information communicated in the COT sharing information. In some other embodiments, the responding UE determines the initiator device location based on information communicated in the COT sharing information in addition to additional information. For example, in some embodiments when the initiator device is a fixed location base station, the responding UE uses the recovered BS ID from the received COT sharing information and a BS ID to location mapping table, stored in the UE, to determine the initiator device location. Operation proceeds from step 531, via connecting node A 536, to step 538.

In step 538 the responding UE determines a gap value, said gap value being a time between the end of the initiator device transmission and the intended start of the responding UE transmission on the COT, which is being shared, said gap value being one of: a value less than 16 micro-sec, 16 micro-sec, or 25 micro-sec, said gap being determined as a function of the responding UE device capabilities and current ongoing status, e.g. ongoing operation, of the responding UE. Operation proceeds from step 538 to step 540.

In step 540 the responding UE determines if the gap is less than 16 micro-seconds. If the determination is that the gap is less than 16 micro-sec, as indicated by Y 541, then operation proceeds from step 540 to step 542. However, if the determination of step 540 is that the gap is not less than 16 micro-seconds, as indicated by N 5411, then operation proceeds from step 540 to step 548.

Returning to step 542, in step 542 the responding device determines whether or not the responding UE knows its location, e.g., to within a predetermined accuracy. If the determination is that that the responding UE knows its location, then operation proceeds from step 542 via step 543 to step 544. If the determination is that that the responding UE does not know its location, then operation proceeds from step 542 via step 551 to step 552.

In step 544 the responding UE determines the distance (D) between the initiating device and the responding UE. Operation proceeds from step 544 to step 545.

In step 545 the responding device makes a decision as to the type of channel access procedure (type 2C or type 2B) to use based on the determined distance (D) and the maximum distance threshold value, e.g., the COT-SharingRange2C value received in the COT sharing information. Step 545 includes step 546, 547 and 549. In step 545 the responding UE compares the determined distance (D) to the maximum distance threshold value (e.g., the COT-SharingRange2C value). If the comparison of step 546 determines that the determined distance D is less than the maximum distance threshold value, then operation proceeds from step 546 to step 547, in which the responding UE decides to use a type 2C channel access procedure. Operation proceeds from step 547 to step 550. Alternatively, if the comparison of step 546 determines that the determined distance D is not less than the maximum distance threshold value, then operation proceeds from step 546 to step 549, in which the responding UE decides to use a type 2B channel access procedure. Operation proceeds from step 549 to step 552.

Returning to step 548, in step 548, the responding UE determines if the gap is 16 micro-sec or is 25 micro-sec. If the determination of step 548 is that the gap is 16 micro-seconds then operation proceeds from step 548 to step 552. Alternatively, if the determination of step 548 is that the gap is 25 micro-sec then operation proceeds from step 548 to step 554.

Returning to step 550, in step 550 the responding UE is operated to perform a type 2C channel access procedure. Thus, the responding UE starts transmitting, using the granted COT resources, immediately after the determined gap without performing channel sensing. Operation proceeds from step 550 to step 556. In step 556 the responding UE is operated to transmit signals, e.g., uplink signals or sidelink signals, using the shared granted COT resources.

Returning to step 552, in step 552 the responding UE is operated to perform a type 2B channel access procedure. Thus, the responding UE performs channel sensing for 16 micro-seconds from the end of the initiating device transmission, and if clear, then the responding UE starts transmitting using the granted COT resources. If the type 2B channel sensing results in a channel clear determination, then operation proceeds from step 552 to step 558, in which the responding UE transmits signals, e.g. uplinks signals or sidelink signals, using the shared granted COT resources.

Returning to step 554, in step 554 the responding UE is operated to perform a type 2A channel access procedure. Thus, the responding UE performs channel sensing starting from the end of the initiating device transmission, and when clear for a continuous interval of 25 micro-seconds, then the responding UE starts transmitting using the granted COT resources. If the type 2A channel sensing results in a channel clear determination, then operation proceeds from step 554 to step 560, in which the responding UE transmits signals, e.g. uplinks signals or sidelink signals, using the shared granted COT resources.

In one exemplary embodiment, the initiator device is base station 1 302 and the responding UE is UE 1 304. In another exemplary embodiment, the initiator device is UE 4 310 and the responding UE is UE 2 306.

It should be appreciated that there may be multiple iterations through the flow portion starting with step 516, e.g., each execution of step 516 being in response to a determined COT sharing opportunity of step 515.

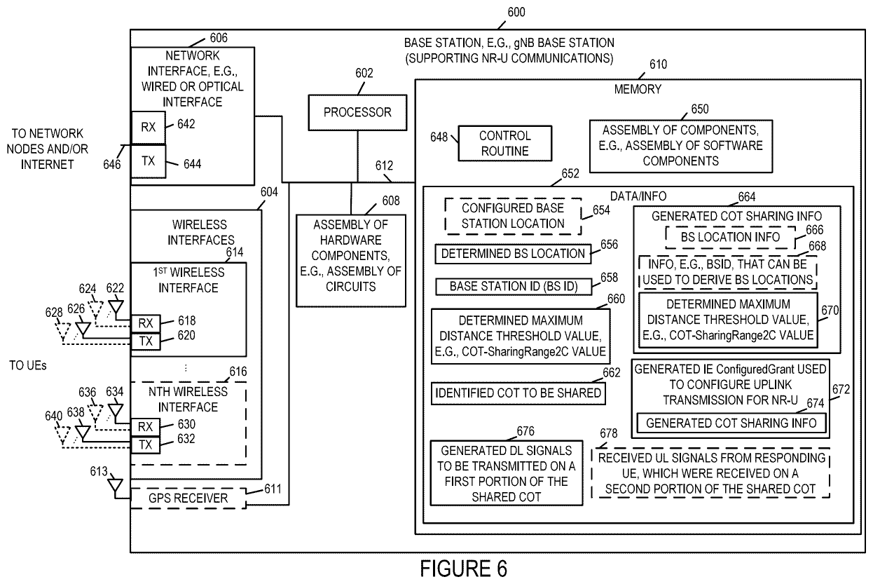

FIG. 6 is a drawing of an exemplary base station 600, e.g., a gNB, supporting NR-U, in accordance with an exemplary embodiment. The exemplary base station 600 is, e.g., base station 302 of FIG. 3 or 4, base station N 322 of FIG. 4, or a base station operating an initiator device with regard to COT sharing for NR-U with respect to the flowchart 500 of FIG. 5 and performing steps of the exemplary method of FIG. 5. Exemplary base station 600 includes a processor 602, e.g., a CPU, wireless interfaces 604, network interface 606, assembly of hardware components 608, e.g., an assembly of circuits, and memory 610 coupled together via a bus 612 over which the various elements may interchange data and information. In some embodiments, base station 600 further includes a GPS receiver 611 coupled to bus 612.

Wireless interfaces 604 includes one or more wireless interfaces (1st wireless interface 614, . . . , Nth wireless interface 613). Different wireless interfaces included in wireless interfaces 604 may correspond to different frequency bands, different communications protocols and/or different communications technologies. 1st wireless interface 614 includes wireless receiver 618 and wireless transmitter 620. Wireless receiver 618 is coupled to one or more antennas or antennas elements (622, . . . , 624) via which the base station 600 receives wireless signals from UEs. Wireless transmitter 620 is coupled to one or more antennas or antennas elements (626, . . . , 628) via which the base station 600 transmits wireless signals to UEs. Nth wireless interface 616 includes wireless receiver 630 and wireless transmitter 632. Wireless receiver 630 is coupled to one or more antennas or antennas elements (634, . . . , 636) via which the base station 600 receives wireless signals from UEs. Wireless transmitter 632 is coupled to one or more antennas or antennas elements (638, . . . , 640) via which the base station 600 transmits wireless signals to UEs. Exemplary wireless signals transmitted by base station 600 include downlink signals communicating COT sharing information including a maximum distance threshold value, e.g., a COT sharing range 2C threshold value, and downlink traffic signals communicated on a first portion of shared COT resources of NR-U spectrum. Exemplary signals received by base station 600 include uplink signals from a UE communicated on a second portion of shared COT resources of NR-U spectrum.

Network interface 606, e.g., a wired or optical interface, includes receiver 642, transmitter 644 and connector 646. Network interface 606 couples the base station 606 to other network nodes and/or the Internet.

GPS receiver 611, when included, receives GPS signals via GPS antenna 613 and processes the GPS signals to determine a position fix, e.g., including the latitude and longitude, for the base station 600. Thus, in some embodiments, the GPS receiver 611 is used to determine the location of the base station 600, and the GPS determined location is stored in the base station and/or communicated to an external storage device, e.g., a location server, which stores a mapping of base station IDs to base station locations, and which may be accessed by UEs. In some embodiments, in which the base station is a fixed location base station, base station 600 configuration information, which includes the known site location of the base station, is loaded into and stored within base station 600.

Memory 610 includes control routine 648, assembly of components 650, e.g., an assembly of software components, and data/information 652. Control routine 648 includes instructions which when executed by processor 602 control the base station 600 to implement basic operational functions, e.g., read memory, write to memory, control an interface, load a program, subroutine, or app, etc. Assembly of components 650, e.g., an assembly of software components, e.g., routines, subroutines, applications, etc., includes, e.g., code, e.g., machine executable instructions, which when executed by processor 602, controls the base station 600 to implement steps of a method, e.g., steps of method performed by a base station, which is an initiator device, described with respect to flowchart 500 of FIG. 5.

Data/information 652 includes a determined base station location 656 for BS 600, a base station ID (BS ID) for BS 600, a determined maximum distance threshold value 660, e.g., a COT-SharingRange2C value, to be communicated to a UE in COT sharing information, information 662 indicating a COT to be shared, and generated COT sharing information 664. Generated COT sharing information 664 includes information corresponding to a COT to be shared including a determined maximum distance threshold value 670, e.g., a COT-SharingRange2C value, to be used by a responding UE in making a decision with regard to whether or not type 2C channel access is to be performed. In some embodiments, the generated COT sharing information 664 includes one or both of base station location information 666 and information 670, e.g., a BS ID, which can be used by a responding UE to derive the base station location. Data/information 664 further includes a generated IE ConfiguredGrant 672 used to configure uplink transmission for NR-U, said generated IE ConfiguredGrant 672 including generated COT sharing information 674, e.g. a copy of generated COT sharing information 664. Data/information 652 further includes generated DL signals 676 to be transmitted on a first portion of the shared COT resources. Data/information 652 may, and sometimes does, includes received UL signals 678 from a responding UE, which were received on a second portion of the shared COT resources corresponding to the received ConfiguredGrant.

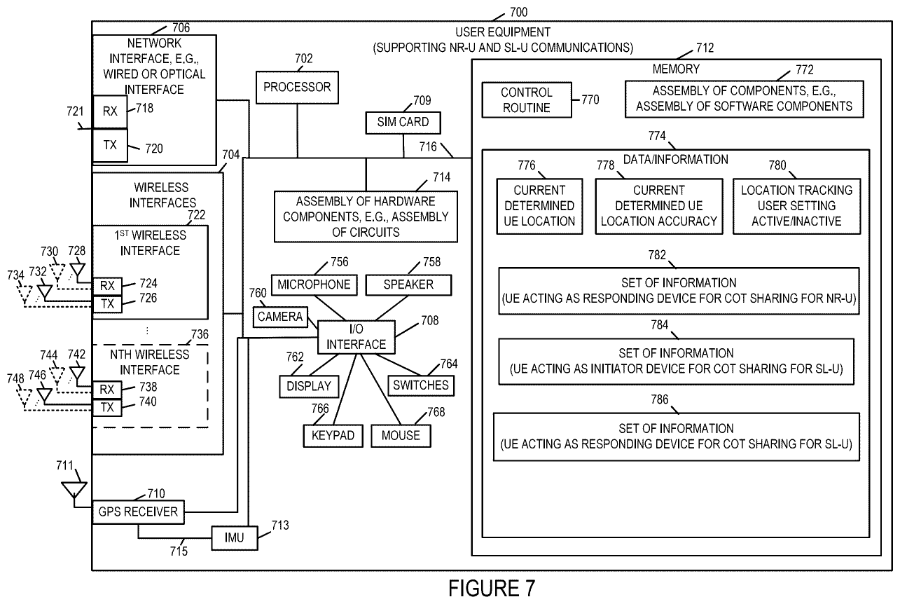

FIG. 7 is a drawing of an exemplary user equipment (UE) 700 supporting NR-U and SL-U, in accordance with an exemplary embodiment. UE 700 is, e.g., any of the UEs (UE 1 304, UE 2 306, UE 3 308, UE 4 310, UE 5 324, UE 6 326, UE 7 328, UE n 330) of FIG. 3 and/or FIG. 4, or a UE operating as an initiator device with regard to COT sharing or a UE operating an a responding device with regard to COT sharing and implementing steps of the exemplary method of flowchart 500 of FIG. 5.

Exemplary UE 700 includes a processor 702, e.g., a CPU, wireless interfaces 704, a network interface 706, an I/O interface 708, a subscriber identity module (SIM) card 709, a GPS receiver 710, an inertial measurement unit (IMU) which includes gyroscopes and accelerometers, e.g., an IMU on a chip, memory 712, and an assembly of hardware components 714, e.g., an assembly of circuits, coupled together via a bus 716 over which the various elements may interchange data and information.

Wireless interfaces 704 includes one or more wireless interfaces (1st wireless interface 722, . . . , Nth wireless interface 736). Different wireless interfaces included in wireless interfaces 704 may correspond to different frequency bands, different communications protocols and/or different communications technologies. 1st wireless interface 722 includes wireless receiver 724 and wireless transmitter 726. Wireless receiver 724 is coupled to one or more antennas or antennas elements (728, . . . , 730) via which the UE 700 receives wireless signals from base station and/or other UEs. Wireless transmitter 726 is coupled to one or more antennas or antennas elements (732, . . . , 734) via which the UE 700 transmits wireless signals to base stations and/or other UEs. Nth wireless interface 736 includes wireless receiver 738 and wireless transmitter 740. Wireless receiver 738 is coupled to one or more antennas or antennas elements (742, . . . , 744) via which the UE 700 receives wireless signals from base stations and/or UEs. Wireless transmitter 740 is coupled to one or more antennas or antennas elements (746, . . . , 748) via which the UE 700 transmits wireless signals to base stations and/or other UEs. In some embodiments one or more of the same antennas or antenna elements are used by a wireless receiver and a wireless transmitter. Exemplary wireless signals transmitted by UE 700 include sidelink signals communicating COT sharing information including a maximum distance threshold value, e.g., a COT sharing range 2C threshold value, when the UE 700 is acting as an initiator device, uplink signals using a granted portion of shared COT NR-U resources when UE 700 is acting as a responding device, and sidelink signals using a granted portion of shared COT SL-U resources when UE 700 is acting as a responding device. Exemplary signals received by UE 700 include downlink signals from a base station, signals communicating COT sharing information from a base station or a UE, and sidelink signals from a UE including sidelink signals communicated on a portion of granted COT SL-U resources.

Network interface 706, e.g., a wired or optical interface, includes receiver 718, transmitter 722 and connector 721 coupled together. Network interface 706 allows the UE 700 to be coupled to network nodes and/or the Internet, via a wireline interface connection, when available.

GPS receiver 710 is coupled to GPS antenna 710 via which the UE 700 receives GPS signals from satellites. IMU 713 is coupled to GPS receiver 713 via connection 715. The GPS receiver 710 determines time, position, and velocity information based on the received GPS signals. In some embodiments, the GPS receiver 710 and/or the processor 702 uses IMU 713 measurement information in addition to the received GPS signals to determine time, position, velocity information, and or other navigation information. For example, the GPS receiver 713 and/or processor 702 uses the IMU information to aid determination of UE location, when GPS reception is unavailable or of low quality. In various embodiments, the GPS receiver 713 and/or the processor 702 determines and outputs an accuracy estimated value, e.g., a CEP value, corresponding to the determined location of the UE 700.

UE 700 further includes a plurality of I/O devices (microphone 756, speaker 758, camera 760, display 762, e.g. a touch screen display, switches 764, keypad 766 and mouse 768) coupled to I/O interface 708, via which the various I/O devices may interface with other elements within UE 700.

Memory 712 includes control routine 770, assembly of components 772, e.g., an assembly of software components, and data/information 744. Control routine 770 includes instructions which when executed by processor 702 control the UE 700 to implement basic operational functions, e.g., read memory, write to memory, control an interface, load a program, subroutine, or app, etc. Assembly of components 772, e.g., an assembly of software components, e.g., routines, subroutines, applications, etc., includes, e.g., code, e.g., machine executable instructions, which when executed by processor 702, controls the UE 700 to implement steps of a method, e.g., steps of method performed by a UE described with respect to flowchart 500 of FIG. 5.

Data/information 774 includes a current determined UE location 776 for UE 700, a current determined location accuracy value 778 corresponding to determined location 776, and a location tracking user setting 780, which can be active indicating that UE 700 is to attempt to determine its location using GPS or inactive indicating that UE 700 is not to attempt to determine its location using GPS. Data/information 774 may further include one or more of: set of information 782, which is a set information corresponding to UE 700 acting as a responding device for COT sharing for NR-U, set of information 784, which is a set information corresponding to UE 700 acting as an initiator device for COT sharing for SL-U, and set of information 786, which is a set information corresponding to UE 700 acting as a responding device for COT sharing for SL-U.

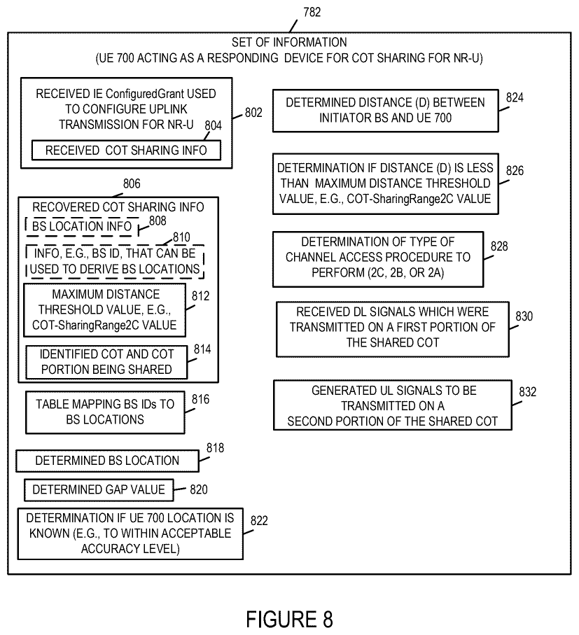

FIG. 8 is a drawing illustrating a more detailed representation of set of information 782, which is a set information corresponding to UE 700 acting as a responding device for COT sharing for NR-U. Set of information 782 includes a received IE ConfiguredGrant used to configured uplink transmission for NR-U 802 including received COT sharing information 804, and recovered COT sharing information 806. Recovered COT sharing information 806 includes a maximum distance threshold value 812, e.g., a COT-SharingRange 2C value, and information 814 identifying the COT and the granted COT portion being shared. In some embodiments, the recovered COT sharing information 806 further includes one or both of: base station location information 808 and information 810, e.g., a BS ID, that can be used to determine the base station location. Set of information 782 further includes a table 816 mapping base station IDs to BS locations, a determined base station location 818, a determined gap value 820, a determination 822 if UE 700's location is known, e.g., to within an acceptable accuracy level, a determined distance (D) 824 between the initiator BS and UE 700, a determination 828 of the type of channel access (CA) procedure to perform (type 2C CA, type 2B CA, or type 2A CA), received DL signals 830 which were transmitted on a first portion of the shared COT, and generated UL signals 832 to be transmitted on a second portion of the shared COT.

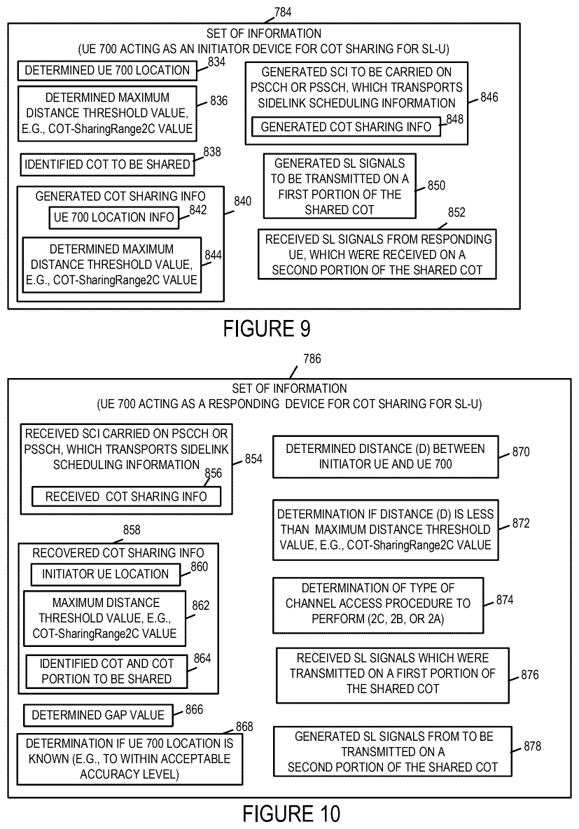

FIG. 9 is a drawing illustrating a more detailed representation of set of information 784, which is a set information corresponding to UE 700 as an initiator device for COT sharing for SL-U. Set of information 784 includes a determined UE 700 location 834, a determined maximum distance threshold value 836, e.g., a COT-SharingRange2C value, information 838 identifying a COT to be shared, and generated COT sharing information 840. The generated COT sharing information 840 includes UE 700 location information 840, e.g. a zone value, and the determined maximum distance threshold value 844, e.g., the COT-SharingRange2C value. Set of information 784 further includes generated Sidelink Control Information (SCI) 846 to be carried on Physical Sidelink Control Channel (PSCCH) or Physical Sidelink Shared Channel (PSSCH), which transports sidelink scheduling information. Information 846 includes the generated COT sharing information 848, e.g., a copy of information 840. Set of information 784 further includes generated SL signals 850 to be transmitted on a first portion of the shared COT, and received SL signals 852 from the responding UE which were received on a second portion of the shared COT.

FIG. 10 is a drawing illustrating a more detailed representation of set of information 786, which is a set information corresponding to UE 700 as a responding device for COT sharing for SL-U. Set of information 786 includes received SCI 854 carried on PSCCH or PSSCH, which transports sidelink scheduling information, said received SCI information 854 includes received COT sharing information 856. Set of information 786 further includes recovered COT sharing information 858 including an initiator UE location 860, e.g. conveyed as a zone ID, a maximum distance threshold value 862, e.g., a COT-SharingRange2C value, and information 864 identifying the COT and the COT portion to be shared. Set of information 786 further includes a determination 868 if UE 700's location is known (e.g., to within an acceptable accuracy level), a determined distance (D) 870 between the initiator UE and UE 700, a determination 872 if the distance (D) is less than the maximum distance threshold value, e.g., the COT-SharingRange2C value, a determination 874 of the type of channel access procedure to perform (type 2C CA, type 2B CA, or type 2A CA), received SL signals 876 which were transmitted on a first portion of the shared COT by the initiator UE, and generated SL signals 878 to be transmitted by UE 700 on a second portion of the shared COT.

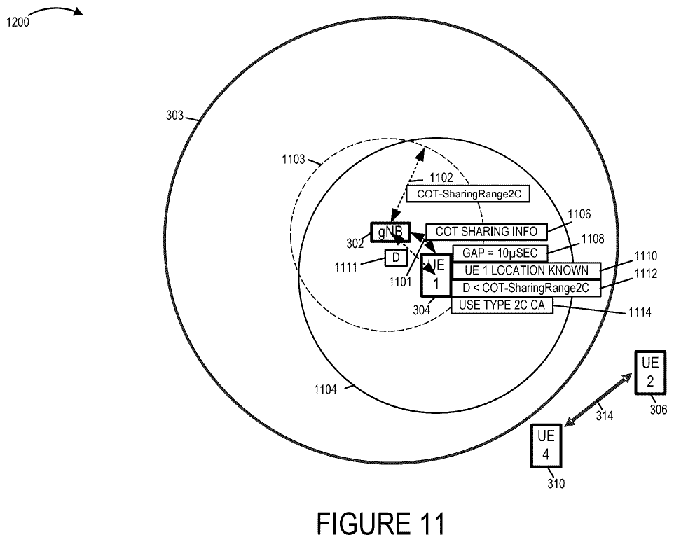

FIG. 11 is a drawing 1100 illustrating an example in which UE 1 304 decides, in accordance with the method of the present invention, to perform type 2C channel access with regard to shared COT resources in NR-U. BS1 302, which is a gNB, has corresponding wireless coverage area 303. BS 1 302 is an initiator device with regard to COT sharing in NR-U. Solid line arrow 1101 represents wireless communications between BS1 302 and UE 1 304. BS1 302 determines a COT-Sharing Range2C value 1102. BS1 302 generates COT sharing information 1106, which includes the COT-SharingRange2C value 1102, and in some embodiments, includes the location of BS1 302 or information, e.g. a BS ID, which can be used to obtain the location of BS1 302. BS1 302 transmits the generated COT sharing information 1106. UE 1 304, which is the responding UE, receives and recovers the COT sharing information 1106. UE 1 304 determines, e.g., based on its capabilities and/or status, that the gap with regard to the COT sharing is to be 10 micro-sec (as indicated by information block 1108), which is a value less than 16 micro-seconds. In this example, UE 1 304 knows its current location to within an acceptable level of accuracy, e.g., based on a recent GPS position fix, as indicated by information block 1110. UE 1 304 determines the distance D 1111 between the initiator device (BS 1 302) and the responding UE (UE 1 304). UE 1 304 compares the determined distance (D) to the recovered COT-SharingRange2C value and determines that D is less than the COT-SharingRange2C value, as indicated by information block 1112. In response to the comparison result 1112, UE 1 304 determines that it is to use type 2C CA (no sensing). Thus, UE 304 starts transmitting immediately on the granted shared resources following the 10 micro-sec gap without having to perform sensing. It may be observed that the transmission range of UE 1 304, as indicated by circle 1104 is expected to be withing cellular coverage area 303 and should not impact signaling 314 between UE 2 306 and UE 4 310.

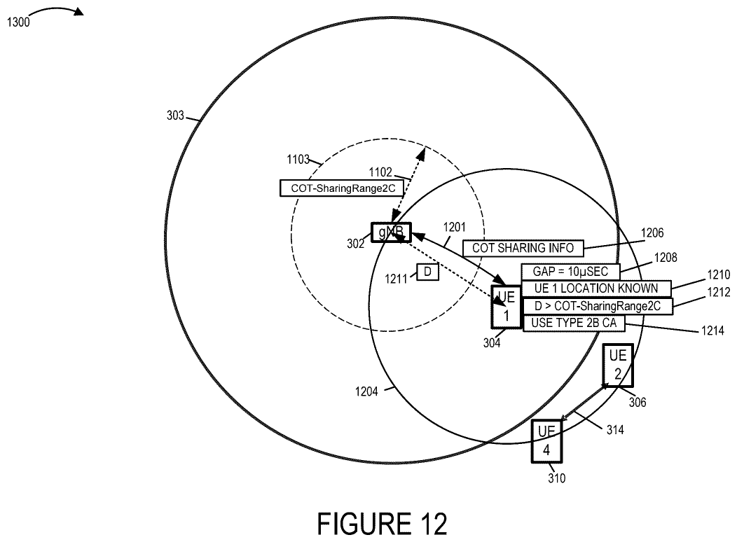

FIG. 12 is a drawing 1200 illustrating an example in which UE 1 304 decides, in accordance with the method of the present invention, to perform type 2B channel access with regard to shared COT resources in NR-U. BS1 302, which is a gNB, has corresponding wireless coverage area 303. BS 1 302 is an initiator device with regard to COT sharing in NR-U. Solid line arrow 1201 represents wireless communications between BS1 302 and UE 1 304. BS1 302 determines a COT-Sharing Range2C value 1102. BS1 302 generates COT sharing information 1206, which includes the COT-SharingRange2C value 1102, and in some embodiments, includes the location of BS1 302 or information, e.g. a BS ID, which can be used to obtain the location of BS1 302. BS1 302 transmits the generated COT sharing information 1206. UE 1 304, which is the responding UE, receives and recovers the COT sharing information 1206. UE 1 304 determines, e.g., based on its capabilities and/or status, that the gap with regard to the COT sharing is to be 10 micro-sec (as indicated by information block 1208), which is a value less than 16 micro-seconds. In this example, UE 1 304 knows its current location to within an acceptable level of accuracy, e.g., based on a recent GPS position fix, as indicated by information block 1210. UE 1 304 determines the distance D 1211 between the initiator device (BS 1 302) and the responding UE (UE 1 304). UE 1 304 compares the determined distance (D) to the recovered COT-SharingRange2C value and determines that D is greater than the COT-SharingRange2C value, as indicated by information block 1212. In response to the comparison result 1212, UE 1 304 determines that it is to use type 2B CA (with required sensing). Thus, UE 304 performs sensing in accordance with type 2B CA procedure, and if channel clear is determined, then the UE 304 may transmit on the granted resources. It may be observed that the transmission range of UE 1 304, as indicated by circle 1204 is expected to be extending beyond cellular coverage area 303 and could impact out-of-sight UEs, such as UE 2 306 and/or UE 4 310, which may be communicating signals 314. Thus, in this case the sensing by UE1 is needed to prevent potential collision with out-of-sight UEs.

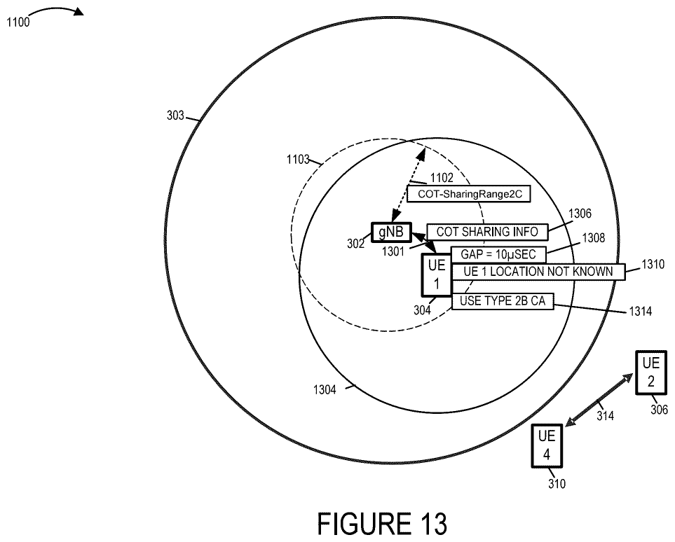

FIG. 13 is a drawing 1300 illustrating an example in which UE 1 304 decides, in accordance with the method of the present invention, to perform type 2B channel access with regard to shared COT resources in NR-U. BS1 302, which is a gNB, has corresponding wireless coverage area 303. BS 1 302 is an initiator device with regard to COT sharing in NR-U. Solid line arrow 1301 represents wireless communications between BS1 302 and UE 1 304. BS1 302 determines a COT-Sharing Range2C value 1102. BS1 302 generates COT sharing information 1306, which includes the COT-SharingRange2C value 1102, and in some embodiments, includes the location of BS1 302 or information, e.g. a BS ID, which can be used to obtain the location of BS1 302. BS1 302 transmits the generated COT sharing information 1306. UE 1 304, which is the responding UE, receives and recovers the COT sharing information 1306. UE 1 304 determines, e.g., based on its capabilities and/or status, that the gap with regard to the COT sharing is to be 10 micro-sec (as indicated by information block 1308), which is a value less than 16 micro-seconds. In this example, UE 1 304 does not know its current location to within an acceptable level of accuracy, e.g., due to poor recent GPS reception, no GPS reception, e.g. due to location such as indoors or in a tunnel, and/or due to the user of UE 304 intentionally turning off UE location tracking or GPS functionality, or due to the UE 304 lacking a GPS module. In response to the determination that UE 1 304 does not know its location, UE 1 304 determines that it is to use type 2B CA (with sensing). Thus, UE 304 performs sensing in accordance with type 2B CA procedure, and if channel clear is determined, then the UE 304 may transmit on the granted resources. In this case the actual range 1304 of UE 1 304 transmission is expected to within cellular coverage area 303, but UE 1 304, which is unaware of its current location, is unable to determine distance D and make a comparison to the threshold COT-SharingRange 2C, so UE 1 304 is controlled to default to using a CA with sensing for safety.

Various aspects and/or features of some embodiments of the present invention are further described below.
In SL, there are configurable variables that enable the NACK-only feedback. In using the NACK-only feedback mechanism, the UEs who are within a specified distance from the transmitter will send the NACK if the reception is failed. The UEs that are outside the specified distance are not required to send any feedback.
The same principles can be, and sometimes are, in accordance with a feature of some embodiments of the present invention, re-used in SL-U and NR-U, to add a distance-based requirement on the UEs that are permitted to perform Type 2c channel access.
The existing variables which can be, and sometimes are, used include:
sl-TransRange which indicates the communication range requirement for the corresponding sl-ZoneConfigMCR-Index. The unit for this variable is, e.g., meter.
sl-ZoneConfig which indicates the zone configuration for the corresponding sl-ZoneConfigMCR-Index.
sl-ZoneConfigMCR-Index which indicates the codepoint of the communication range requirement field in SCI.
sl-ZoneLength which indicates the length of each geographic zone.
If UE's location information is available and the distance between UE's location and the central location of the nearest zone that is calculated based on the Zone id in the SCI and the value of sl-ZoneLength is smaller or equal to the communication range requirement in the SCI, the UE is required to send NACK feedback when needed.
The UE shall determine an identity of the zone (i.e. Zone_id) in which it is located using the formulae shown below.

An exemplary method of the calculation of Zone ID, used in some embodiments of the present invention, is described below. As part of the example method, in some embodiments the UE shall determine an identity of the zone (i.e. Zone_id) in which it is located using the following formulae, if sl-ZoneConfig is configured:

$$\cdot x 1 = Floor ( x / L ) Mod 64 ;$$

$$\cdot y 1 = Floor ( y / L ) Mod 64 ;$$

$$\cdot Zone\_id = y 1 * 64 + x 1.$$

The parameters in the formulae are defined as follows:
L is the value of sl-ZoneLength included in sl-ZoneConfig;
x is the geodesic distance in longitude between UE's current location and geographical coordinates (0, 0) according to WGS84 model and it is expressed in meters;
y is the geodesic distance in latitude between UE's current location and geographical coordinates (0, 0) according to WGS84 model and it is expressed in meters.

In some exemplary embodiments, in accordance with a feature of the present invention, variables in COT sharing information of NR-U and SL-U are included and configured, so the UEs can determine their distance from the COT initiator.

In some embodiments, in accordance with a feature of the present invention, responding UEs in SL-U, use the configured values in COT sharing information to determine their eligibility to perform Type 2C channel access.

In some embodiments, in accordance with a feature of the present invention, the responding UEs in NR-U, use the configured values in COT sharing information to determine their eligibility to perform Type 2C channel access.

In some embodiments, in accordance with a feature of the present invention, a mechanism is used to configure the required maximum distance from the initiator to perform Type 2c channel access. In some such embodiments, the maximum distance is configured based on one or more or all of: the energy threshold in ED, channel propagation loss and transmit power of the initiator and responding UEs.

In some embodiments, in accordance with a feature of the present invention, if the responding UEs are within the specified distance from the initiator and are within the time gap (16 μs), they can perform the type 2c channel access, otherwise, they will fall back to type 2a/2b channel access.

In some embodiments, in accordance with a feature of the present invention, if the responding UEs are unable to determine their distance from the initiator, they will use type 2a/2b channel access.

### Appendix/Features Relating to: NR-U

The IE ConfiguredGrantConfig is used to configure uplink transmission.
In some embodiments, of the present invention, the new element COT-SharingRange2C (shown below) is added to the IE ConfiguredGrantConfig.

| CG-COT-Sharing-r16 ::= CHOICE { | |
|---|---|
| noCOT-Sharing-r16 | NULL, |
| cot-Sharing-r16 | SEQUENCE { |
| duration-r16 | INTEGER (1..39), |
| offset-r16 | INTEGER (1..39), |
| channelAccessPriority-r16 | INTEGER (1..4) |
| COT-SharingRange2C | INTEGER [m] |
| } | |
| } | |
| CG-COT-Sharing-r17 ::= CHOICE { | |
| noCOT-Sharing-r17 | NULL, |
| cot-Sharing-r17 | SEQUENCE { |
| duration-r17 | INTEGER (1..319), |
| offset-r17 | INTEGER (1..319) |
| COT-SharingRange2C | INTEGER [m] |

}
}

### Appendix/Features Relating to: SL-U

SCI carried on PSSCH is a 2nd-stage SCI, which transports sidelink scheduling, information, and/or inter-UE coordination related information.
In some embodiments of the present invention, the new element COT-SharingRange2C is added.
HARQ process number—4 bits.
New data indicator—1 bit.
Redundancy version—2 bits
Source ID—8 bits
Destination ID—16 bits
HARQ feedback enabled/disabled indicator—1 bit
Cast type indicator—2 bits
CSI request—1 bit
If the ‘COT sharing flag’ field in SCI format 1 is present and set to ‘1’, all the remaining fields are set:
CAPC—2 bits
COT sharing cast type—2 bits
COT sharing additional ID—24 bits.
Remaining COT duration—┐log₂(10.2^{μ})┌ bits
Zone ID—12 bits
COT-SharingRange2C.

### First Numbered List of Exemplary Method Embodiments

Method Embodiment 1. A method of operating a communications device (e.g., a responding UE that uses communications resources authorized to be used by the UE in a COT sharing information received from an initiator device), the method comprising: receiving (528) first COT sharing information from an initiator device, said first COT sharing information including a maximum distance threshold value (e.g., COT sharing range 2C threshold value); and determining (544) the distance between the initiator device and the communications device.

Method Embodiment 1A. The method of Method Embodiment 1, further comprising: making a decision (545) as to a type of channel access procedure (Type 2C or 2B) based on the distance and the maximum distance threshold value.

Method Embodiment 1B. The method of Method Embodiment 1A, further comprising: prior to said step of making a decision (545) as to a type of channel access procedure (Type 2C or 2B) based on the distance and the maximum distance threshold value, determining (543) that the communications device knows its current location (e.g., to within a predetermined acceptable threshold level.)

Method Embodiment 2. The method of Method Embodiment 1A, further comprising: determining (531) the location of the initiator device prior to determining (544) the distance between the initiator device and the communications device.

Method Embodiment 3. The method of Method Embodiment 2, wherein determining (531) the location of the initiator device includes: recovering (532) the initiator device location from the received first COT sharing information or using (534) information included in the received first COT sharing information to determine the initiator device location.

Method Embodiment 4. The method of Method Embodiment 2, wherein making a decision (545) as to a type of channel access procedure (Type 2C or 2B) based on the distance and the maximum distance threshold value includes: deciding (547), when the determined distance between the initiating device and the communications device is less than the maximum distance threshold value, that a first type (Type 2C) channel access operation which does not require channel sensing before transmission be used; and deciding (549), when the determined distance between the initiating device and the communications device is not less than the maximum distance threshold value, that a second type (Type 2B) channel access operation which requires channel sensing before transmission is be used.

Method Embodiment 5. The method of Method Embodiment 4, wherein the received first COT sharing information includes the determined maximum distance threshold value.

Method Embodiment 6. The method of Method Embodiment 5, wherein the received first COT sharing information further includes information indicating the location of the initiator device.

Method Embodiment 7. The method of Method Embodiment 5, wherein the initiator device is a base station.

Method Embodiment 8. The method of Method Embodiment 7, wherein the base station is a fixed base station and wherein the first COT sharing information includes the ID of the base station (thereby allowing the base station ID to be used to lookup the location of the base station which is the monitor device from stored base station location information).

Method Embodiment 8A. The method of Method Embodiment 7, further comprising: prior to said step of receiving (528) first COT sharing information from an initiator device, storing (502) a set of base station ID to base station location information (e.g., an ID to location mapping table for fixed location BSs).

Method Embodiment 9. The method of Method Embodiment 5, wherein said initiator device is a first UE operating in a sidelink mode of operation and wherein said communications device is a second UE device.

Method Embodiment 10. The method of Method Embodiment 1A, further comprising: receiving (528 (second iteration)) second COT sharing information from the initiator device, said second COT sharing information including said maximum distance threshold value (e.g., COT sharing range 2C threshold value), said second sharing information corresponding to a different COT sharing opportunity than a first COT sharing opportunity to which said first COT sharing information corresponds; and determining (542) if the communications device knows its (current) location (e.g., to within a specified accuracy).

Method Embodiment 11. The method of Method Embodiment 10, wherein determining (542) if the communications device knows it location includes: determining (551) that the communications device does not know its (current) location (e.g., to within the specified accuracy); and in response to determining (551) that the communications device does not know its (current) location (e.g., to within the specified accuracy), performing (552) a channel access procedure (e.g., type 2B channel access procedure) requiring channel sensing prior to transmission for the second COT sharing opportunity.

Method Embodiment 12. The method of Method Embodiment 1, further comprising: determining (541) a gap value to be less than 16 micro-seconds, said gap value being a time between end of transmission by said initiator device and an intended start of transmission by said communications device for a shared COT corresponding to said received first COT sharing information.

Method Embodiment 13. The method of Method Embodiment 11, further comprising: determining (541) a first gap value to be less than 16 micro-seconds, said first gap value being a time between end of transmission by said initiator device and an intended start of transmission by said communications device for a shared COT corresponding to said received first COT sharing information; and determining (541 (second iteration)) a second gap value to be less than 16 micro-seconds, said second gap value being a time between end of transmission by said initiator device and an intended start of transmission by said communications device for a shared COT corresponding to said received second COT sharing information.

### First Numbered List of Exemplary Apparatus Embodiments

Apparatus Embodiment 1. A communications device (e.g., a responding UE (304 or 310 or 700) that uses communications resources authorized to be used by the UE in a COT sharing information received from an initiator device (BS 302 or UE 306)), the communications device comprising: a wireless receiver (724); and a processor (702) configured to: operate the communications device to receive (528) (via the wireless receiver) first COT sharing information from an initiator device, said first COT sharing information including a maximum distance threshold value (e.g., COT sharing range 2C threshold value); and determine (544) the distance between the initiator device and the communications device.

Apparatus Embodiment 1A. The communications device of Apparatus Embodiment 1, wherein said processor is further configured to: make a decision (545) as to a type of channel access procedure (Type 2C or 2B) based on the distance and the maximum distance threshold value.

Apparatus Embodiment 1B. The communications device of Apparatus Embodiment 1A, wherein said processor is further configured to: prior to said step of making a decision (545) as to a type of channel access procedure (Type 2C or 2B) based on the distance and the maximum distance threshold value, determine (543) that the communications device knows its current location (e.g., to within a predetermined acceptable threshold level.)

Apparatus Embodiment 2. The communications device of Apparatus Embodiment 1A, wherein said processor is configured to: operate the communications device to determine (531) the location of the initiator device prior to determining (544) the distance between the initiator device and the communications device.

Apparatus Embodiment 3. The communications device of Apparatus Embodiment 2, wherein said processor is configured to operate the communications device to: recover (532) the initiator device location from the received first COT sharing information or use (534) information included in the received first COT sharing information to determine the initiator device location, as part of being configured to operate the communications device to determine (531) the location of the initiator device.

Apparatus Embodiment 4. The communications device of Apparatus Embodiment 2, wherein said processor is configured to operate the communications device to: decide (547), when the determined distance between the initiating device and the communications device is less than the maximum distance threshold value, that a first type (Type 2C) channel access operation which does not require channel sensing before transmission be used; and decide (549), when the determined distance between the initiating device and the communications device is not less than the maximum distance threshold value, that a second type (Type 2B) channel access operation which requires channel sensing before transmission is be used, as part of being configured to operate the communications device to make a decision (545) as to a type of channel access procedure (Type 2C or 2B) based on the distance and the maximum distance threshold value.

Apparatus Embodiment 5. The communications device of Apparatus Embodiment 4, wherein the received first COT sharing information includes the determined maximum distance threshold value.

Apparatus Embodiment 6. The communications device of Apparatus Embodiment 5, wherein the received first COT sharing information further includes information indicating the location of the initiator device.

Apparatus Embodiment 7. The communications device of Apparatus Embodiment 5, wherein the initiator device is a base station (302) (e.g., a gNB supporting NR-U).

Apparatus Embodiment 8. The communications device of Apparatus Embodiment 7, wherein the base station is a fixed base station and wherein the first COT sharing information includes the ID of the base station (thereby allowing the base station ID to be used to lookup the location of the base station which is the monitor device from stored base station location information).

Apparatus Embodiment 8A. The communications device of Apparatus Embodiment 7, wherein said processor is further configured to operate the communications device to: prior to said step of receiving (528) first COT sharing information from an initiator device, store (502) a set of base station ID to base station location information (e.g., an ID to location mapping table for fixed location BSs).

Apparatus Embodiment 9. The communications device of Apparatus Embodiment 5, wherein said initiator device is a first UE (306) operating in a sidelink mode of operation and wherein said communications device is a second UE device (310).

Apparatus Embodiment 10. The communications device of Apparatus Embodiment 1A, wherein said processor is further configured to operate the communications device to: receive (528 (second iteration)) (via the wireless receiver) second COT sharing information from the initiator device, said second COT sharing information including said maximum distance threshold value (e.g., COT sharing range 2C threshold value), said second sharing information corresponding to a different COT sharing opportunity than a first COT sharing opportunity to which said first COT sharing information corresponds; and determine (542) if the communications device knows its (current) location (e.g., to within a specified accuracy).

Apparatus Embodiment 11. The communications device of Apparatus Embodiment 10, wherein said processor is configured to: determine (551) that the communications device does not know its (current) location (e.g., to within the specified accuracy), as part of being configured to determine (542) if the communications device knows it location; and in response to determining (551) that the communications device does not know its (current) location (e.g., to within the specified accuracy), operate the communications device to perform (552) a channel access procedure (e.g., type 2B channel access procedure) requiring channel sensing prior to transmission for the second COT sharing opportunity.

Apparatus Embodiment 12. The communications device of Apparatus Embodiment 1, wherein said processor is further configured to: operate the communications device to determine (541) a gap value; and wherein said gap value is determined to be less than 16 micro-seconds, said gap value being a time between end of transmission by said initiator device and an intended start of transmission by said communications device for a shared COT corresponding to said received first COT sharing information.

Apparatus Embodiment 13. The communications device of Apparatus Embodiment 11, wherein said processor is further configured to: operate the communications device to determine (541) a gap value for each COT sharing opportunity; wherein said communications device determines (541 first iteration)) a first gap value to be less than 16 micro-seconds, said first gap value being a time between end of transmission by said initiator device and an intended start of transmission by said communications device for a shared COT corresponding to said received first COT sharing information; and wherein said communications device determine (541 (second iteration)) a second gap value to be less than 16 micro-seconds, said second gap value being a time between end of transmission by said initiator device and an intended start of transmission by said communications device for a shared COT corresponding to said received second COT sharing information.

### First Numbered List of Exemplary Non-Transitory Computer Readable Medium Embodiments

Non-Transitory Computer Readable Medium Embodiment 1. A non-transitory computer readable medium (712) including machine executable instructions, which when executed by a processor (702) of a communications device (304 or 310 or 700) (e.g., a responding UE that uses communications resources authorized to be used by the UE in a COT sharing information received from an initiator device), cause the communications device to perform the steps of: receiving (528) first COT sharing information from an initiator device, said first COT sharing information including a maximum distance threshold value (e.g., COT sharing range 2C threshold value); and determining (544) the distance between the initiator device and the communications device.

### Second Numbered List of Exemplary Method Embodiments

Method Embodiment 1. A method of operating a communications device (e.g., an initiator device that gives permission to one or more other devices to use resources available for use by the initiator device), comprising: determining (512) a maximum distance threshold value (e.g., a COT sharing range_2C threshold value); generating (516) COT sharing (544) information, said COT sharing information including the maximum distance threshold value; and transmitting (526) the COT sharing information.

Method Embodiment 2. The method of Method Embodiment 1, wherein the maximum distance threshold value is a distance indicator used to indicate a distance which is to be considered by a receiving device when the receiving device makes a determination whether it can proceed with a transmission using resources shared by the communications device without having to first perform channel sensing.

Method Embodiment 3. The method of Method Embodiment 1, wherein the communications device is a COT sharing initiator device; and wherein generating (516) COT sharing information includes: including (520) in the COT information, location information indicating the location of the initiator device.

Method Embodiment 4. The method of Method Embodiment 3, wherein the communications device is a User Equipment (UE).

Method Embodiment 5. The method of Method Embodiment 4, wherein transmitting (526) the COT sharing information includes transmitting the COT sharing information in an information element (IE) of sidelink control information (SCI) communicated on a physical sidelink control channel (PSCCH) or a physical sidelink shared channel (PSSCH).

Method Embodiment 6. The method of Method Embodiment 1, wherein the communications device is a COT sharing initiator device which is a fixed device positioned at a fixed location; and wherein generating (516) COT sharing information includes: including (522) in the COT information location information a device identifier corresponding to the communications device which can be used to look up the location of the initiator device.

Method Embodiment 7. The method of Method Embodiment 6, further comprising: storing (507) the fixed location information corresponding to the device in a storage device (e.g., network storage device or memory in the UE which stores base station or fixed device location information along with device identifier information allowing the location of the device to be determined through a lookup using the device identifier) that is accessible to one or more devices receiving the COT information.

Method Embodiment 8. The method of Method Embodiment 1, wherein the communications device is a base station; and wherein transmitting (526) the COT sharing information includes transmitting the COT sharing information in an information element (IE) of a grant (e.g., ConfiguredGrant) used to configure uplink transmission for NR-U.

### Second Numbered List of Exemplary Apparatus Embodiments

Apparatus Embodiment 1. A communications device (e.g., an initiator device ((BS1 302 or BS 600) or (UE 2 306 or UE 700) that gives permission to one or more other devices (UE 1 304 or UE 4 310) to use resources available for use by the initiator device), comprising: a wireless transmitter (620 or 726); and a processor (602 or 702) configured to operate the communications device to: determine (512) a maximum distance threshold value (e.g., a COT sharing range_2C threshold value); generate (516) COT sharing (544) information, said COT sharing information including the maximum distance threshold value; and transmit (526) (via the wireless transmitter (620 or 726)) the COT sharing information.

Apparatus Embodiment 2. The communications device of Apparatus Embodiment 1, wherein the maximum distance threshold value is a distance indicator used to indicate a distance which is to be considered by a receiving device when the receiving device makes a determination whether it can proceed with a transmission using resources shared by the communications device without having to first perform channel sensing.

Apparatus Embodiment 3. The communications device of Apparatus Embodiment 1, wherein the communications device is a COT sharing initiator device; and wherein said processor is configured to operate the communications device to: include (520) in the COT information, location information indicating the location of the initiator device, as part of being configured to operate the communications device to generate (516) COT sharing information.

Apparatus Embodiment 4. The communications device of Apparatus Embodiment 3, wherein the communications device is a User Equipment (UE) (UE 2 306).

Apparatus Embodiment 5. The communications device of Apparatus Embodiment 4, wherein said processor is configured to: operate the communications device to transmit (via wireless transmitter 726) the COT sharing information in an information element (IE) of sidelink control information (SCI) communicated on a physical sidelink control channel (PSCCH) or a physical sidelink shared channel (PSSCH), as part of being configured to operate the communications device to transmit (526) the COT sharing information.

Apparatus Embodiment 6. The communications device of Apparatus Embodiment 1, wherein the communications device is a COT sharing initiator device which is a fixed device (e.g., BS1 302) positioned at a fixed location; and wherein said processor (602) is configured to operate the communications device to: include (522) in the COT information location information a device identifier (e.g., BS ID) corresponding to the communications device which can be used to look up the location of the initiator device, as part of being configured to operate the communications device to generate (516) COT sharing information.

Apparatus Embodiment 7. The communications device of Apparatus Embodiment 6, wherein said processor (602) is further configured to operate the communications device to: store (507) the fixed location information corresponding to the device in a storage device (e.g., network storage device (305) or memory in the UE which stores base station or fixed device location information along with device identifier information allowing the location of the device to be determined through a lookup using the device identifier) that is accessible to one or more devices receiving the COT information.

Apparatus Embodiment 8. The communications device of Apparatus Embodiment 1, wherein the communications device is a base station (BS1 302); and wherein said processor (602) is configured to operate the communications device to: transmit (via wireless transmitter 620) the COT sharing information in an information element (IE) of a grant (e.g., ConfiguredGrant) used to configure uplink transmission for NR-U, as part of operating the communications device to transmit (526) the COT sharing information.

### Second Numbered List of Exemplary Non-Transitory Computer Readable Medium Embodiments

Non-Transitory Computer Readable Medium Embodiment 1. A non-transitory computer readable medium (610 or 712) including machine executable instructions, which when executed by a processor (602 or 702) of a communications device ((BS1 302 or BS 600) or (UE 2 306 or UE 700)) (e.g., an initiator device that gives permission to one or more other devices to use resources available for use by the initiator device) causes the communications device to perform the steps of: determining (512) a maximum distance threshold value (e.g., a COT sharing range_2C threshold value); generating (516) COT sharing (544) information, said COT sharing information including the maximum distance threshold value; and transmit (526) the COT sharing information.

The techniques of various embodiments may be implemented using software, hardware and/or a combination of software and hardware. Various embodiments are directed to apparatus, e.g., user equipment (UE) devices supporting NR-U and/or SL-U, base stations, e.g. gNBs supporting NR-U and/or SL-U, communications devices such as gateways, e.g., RGs, 5G-RGs, routers, e.g., home routers, W-AGFs, core network devices (e.g., AMF devices, PCF devices, SMF devices, UPF devices, UDM devices, UDR devices etc.), access network devices (e.g., base stations, e.g., HgNB femtocell CBRS base stations, gNBs, WiFi access nodes, e.g., WiFi APs, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating communications devices such as user equipment (UE) devices supporting NR-U and/or SL-U, base stations, e.g. gNBs supporting NR-U and/or SL-U, gateways, e.g. RGs, e.g., 5G-RG devices, routers such as home routers, W-AGF devices, end user devices such as end user devices supporting both cellular and WiFi communications and end user devices supporting WiFi communications, user equipment (UE) devices, core network devices (e.g., AMF devices, PCF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g., HgNB femtocell CBRS base stations, Access Points, e.g., WiFi APs, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., communications devices such as user equipment (UE) devices supporting NR-U and/or SL-U, base stations, e.g. gNBs supporting NR-U and/or SL-U, gateways, e.g. residential gateways (RGs), e.g., 5G-RG devices, routers, e.g., home routers, W-AGF devices, end user devices, e.g., end user devices supporting both cellular and WiFi communications and end user devices supporting WiFi communications, user equipment (UE) devices, core network devices (e.g., PCF devices, AMF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g., HgNB femtocell CBRS base stations, Access Points, e.g., WiFi APs, wireless routers, switches, WLAN controllers, orchestration servers, orchestrators, Gateways, AAA servers, servers, nodes and/or elements described herein are implemented using one or more components to perform the steps corresponding to one or more methods, for example, provisioning user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, UEs, base stations, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., communications devices such as user equipment (UE) devices supporting NR-U and/or SL-U, base stations, e.g. gNBs supporting NR-U and/or SL-U, gateways, e.g., residential gateways (RGs), e.g., 5G-RG devices, routers, e.g., home routers, W-AGF devices, 3GPP access network devices, end user devices, e.g., end user devices supporting both cellular and WiFi communications, user (UE) devices, core network devices (e.g., PCF devices, AMF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g. HgNB CBRS femetocell base stations, Access Points, e.g., WiFi APs, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., communications devices such as a user equipment (UE) device supporting NR-U and/or SL-U, a base station, e.g. gNB supporting NR-U and/or SL-U, gateways, e.g., residential gateways (RGs), e.g., 5G-RG devices, W-AGF devices, end user devices, e.g., end user devices supporting both cellular and WiFi communications and end user devices supporting WiFi communications, a user equipment (UE) devices, core network devices (e.g., PCF devices, AMF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g. HgNB CBRS femtocell base stations, Access Points, e.g., WiFi APs, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., a user equipment (UE) device supporting NR-U and/or SL-U, a base station, e.g. gNB supporting NR-U and/or SL-U, a gateway such as a residential gateway (RG), e.g., a 5G-RG devices, a w-AGF device, an end user device, e.g., an end user device supporting both cellular and WiFi communications or an end user device supporting WiFi communications, a 3GPP access network device, user equipment (UE) device, core network device (e.g., PCF device, AMF device, SMF device, UPF device, EDM device, UDR device, etc.), wireless device, mobile device, smartphone, subscriber device, desktop computer, printer, IPTV, laptop, tablet, network edge device, Access Point, e.g., a WiFi AP, a wireless router, switch, WLAN controller, orchestration server, orchestrator, Gateway, AAA server, server, node and/or element, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., a communications device such as a user equipment (UE) device supporting NR-U and/or SL-U, a base station, e.g. a gNB supporting NR-U and/or SL-U, a gateway, e.g., a residential gateway (RG), e.g., 5G-RG devices, W-AGF devices, 3GPP access network devices, end user devices, e.g., end user device supporting cellular and WiFi communications or an end user device supporting WiFi communications, user (UE) devices, core network devices (e.g., PCF devices, AMF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g. a HgNB CBRS femtocell base station, Access Points, e.g., WiFi APs, wireless routers, switches, WLAN controllers, orchestration servers, orchestrators, Gateways, AAA servers, servers, nodes and/or elements. The code may be in the form of machine, e.g., computer, executable Instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a user equipment (UE) device supporting NR-U and/or SL-U, a base station, e.g. gNB supporting NR-U and/or SL-U, a gateway such as a residential gateway (RG), e.g. a 5G-RG device, a router, e.g., a home router, a W-AGF device, a 3GPP access network device, e.g., a gNB, an end user device such as an end user device supporting both cellular and WiFi communications or an end user device supporting WiFi communications, a user equipment (UE) device, core network device (e.g., PCF device, AMF device, SMF device, UPF device, UDM device, UDR device, etc.), wireless device, mobile device, smartphone, subscriber device, desktop computer, printer, IPTV, laptop, tablets, network edge device, a base station, e.g., a HgNB CBRS femtocell base station, and Access Point, e.g., a WiFi AP, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a communications device, the method comprising:
receiving first COT sharing information from an initiator device, said first COT sharing information including a maximum distance threshold value; and
determining the distance between the initiator device and the communications device.

2. The method of claim 1, further comprising:
making a decision as to a type of channel access procedure based on the distance and the maximum distance threshold value.

3. The method of claim 2, further comprising:
determining the location of the initiator device prior to determining the distance between the initiator device and the communications device.

4. The method of claim 3, wherein determining the location of the initiator device includes:
recovering the initiator device location from the received first COT sharing information or using information included in the received first COT sharing information to determine the initiator device location.

5. The method of claim 3, wherein making a decision as to a type of channel access procedure based on the distance and the maximum distance threshold value includes:
deciding, when the determined distance between the initiating device and the communications device is less than the maximum distance threshold value, that a first type channel access operation which does not require channel sensing before transmission be used; and
deciding, when the determined distance between the initiating device and the communications device is not less than the maximum distance threshold value, that a second type channel access operation which requires channel sensing before transmission is be used.

6. The method of claim 5, wherein the received first COT sharing information includes the determined maximum distance threshold value.

7. The method of claim 6, wherein the received first COT sharing information further includes information indicating the location of the initiator device.

8. The method of claim 6, wherein the initiator device is a base station; and wherein the base station is a fixed base station and wherein the first COT sharing information includes the ID of the base station.

9. The method of claim 6, wherein said initiator device is a first UE operating in a sidelink mode of operation and wherein said communications device is a second UE device.

10. The method of claim 2, further comprising:
receiving second COT sharing information from the initiator device, said second COT sharing information including said maximum distance threshold value, said second sharing information corresponding to a different COT sharing opportunity than a first COT sharing opportunity to which said first COT sharing information corresponds;
determining if the communications device knows its location; and
wherein determining if the communications device knows it location includes:
determining that the communications device does not know its location; and
in response to determining that the communications device does not know its location, performing a channel access procedure requiring channel sensing prior to transmission for the second COT sharing opportunity.

11. A communications device, the communications device comprising:
a wireless receiver; and
a processor configured to:
operate the communications device to receive first COT sharing information from an initiator device, said first COT sharing information including a maximum distance threshold value; and
determine the distance between the initiator device and the communications device.

12. The communications device of claim 11, wherein said processor is further configured to:
make a decision as to a type of channel access procedure based on the distance and the maximum distance threshold value.

13. The communications device of claim 12, wherein said processor is configured to:
operate the communications device to determine the location of the initiator device prior to determining the distance between the initiator device and the communications device.

14. The communications device of claim 13, wherein said processor is configured to operate the communications device to:
recover the initiator device location from the received first COT sharing information or use information included in the received first COT sharing information to determine the initiator device location, as part of being configured to operate the communications device to determine the location of the initiator device.

15. The communications device of claim 13, wherein said processor is configured to operate the communications device to:
decide, when the determined distance between the initiating device and the communications device is less than the maximum distance threshold value, that a first type channel access operation which does not require channel sensing before transmission be used; and
decide, when the determined distance between the initiating device and the communications device is not less than the maximum distance threshold value, that a second type channel access operation which requires channel sensing before transmission is be used,
as part of being configured to operate the communications device to make a decision as to a type of channel access procedure based on the distance and the maximum distance threshold value.

16. A method of operating a communications device, comprising:
determining a maximum distance threshold value;
generating COT sharing information, said COT sharing information including the maximum distance threshold value; and
transmitting the COT sharing information.

17. The method of claim 16, wherein the maximum distance threshold value is a distance indicator used to indicate a distance which is to be considered by a receiving device when the receiving device makes a determination whether it can proceed with a transmission using resources shared by the communications device without having to first perform channel sensing.

18. The method of claim 16,
wherein the communications device is a COT sharing initiator device; and
wherein generating COT sharing information includes:
including in the COT information, location information indicating the location of the initiator device.

19. The method of claim 18,
wherein the communications device is a User Equipment (UE).

20. The method of claim 19,
wherein transmitting the COT sharing information includes transmitting the COT sharing information in an information element (IE) of sidelink control information (SCI) communicated on a physical sidelink control channel (PSCCH) or a physical sidelink shared channel (PSSCH).

21. The method of claim 16,
wherein the communications device is a COT sharing initiator device which is a fixed device positioned at a fixed location; and
wherein generating COT sharing information includes:
including in the COT information location information a device identifier corresponding to the communications device which can be used to look up the location of the initiator device.

22. The method of claim 21, further comprising:
storing the fixed location information corresponding to the device in a storage device that is accessible to one or more devices receiving the COT information.

23. The method of claim 16,
wherein the communications device is a base station; and
wherein transmitting the COT sharing information includes transmitting the COT sharing information in an information element (IE) of a grant used to configure uplink transmission for NR-U.

24. A communications device, comprising:
a wireless transmitter; and
a processor configured to operate the communications device to:
determine a maximum distance threshold value;
generate COT sharing information, said COT sharing information including the maximum distance threshold value; and
transmit the COT sharing information.

25. The communications device of claim 24, wherein the maximum distance threshold value is a distance indicator used to indicate a distance which is to be considered by a receiving device when the receiving device makes a determination whether it can proceed with a transmission using resources shared by the communications device without having to first perform channel sensing.

26. The communications device of claim 24,
wherein the communications device is a COT sharing initiator device; and
wherein said processor is configured to operate the communications device to:
include in the COT information, location information indicating the location of the initiator device, as part of being configured to operate the communications device to generate COT sharing information.

27. The communications device of claim 26,
wherein the communications device is a User Equipment (UE).

28. The communications device of claim 27, wherein said processor is configured to:
operate the communications device to transmit the COT sharing information in an information element (IE) of sidelink control information (SCI) communicated on a physical sidelink control channel (PSCCH) or a physical sidelink shared channel (PSSCH), as part of being configured to operate the communications device to transmit the COT sharing information.

29. The communications device of claim 24,
wherein the communications device is a COT sharing initiator device which is a fixed device positioned at a fixed location; and
wherein said processor is configured to operate the communications device to:
include in the COT information location information a device identifier corresponding to the communications device which can be used to look up the location of the initiator device, as part of being configured to operate the communications device to generate COT sharing information.

30. The communications device of claim 29, wherein said processor is further configured to operate the communications device to:
store the fixed location information corresponding to the device in a storage device that is accessible to one or more devices receiving the COT information.
